(19) United States
(12) Patent Application Publication
(10) Pub. No.: US 2012/0133910 A1
(43) Pub. Date: May 31, 2012

(54) OPTICAL DIGITAL DISPLAY APPARATUS

(75) Inventor: WEN-CHUN WU, TAINAN CITY (TW)

(73) Assignee: WELMORE CO., LTD., TAIPEI CITY (TW)

(21) Appl. No.: 13/004,214

(22) Filed: Jan. 11, 2011

(30) Foreign Application Priority Data
Nov. 26, 2010 (TW) 099140885

(51) Int. Cl. G03B 21/28; G03B 21/14

(52) U.S. Cl. 353/99; 353/119

(57) ABSTRACT

The present invention relates to an optical digital display apparatus, which comprises a housing, at least a display module, and an optical projecting lens set. The housing has a frame. The display module is disposed on one side in the frame and emits display light. The optical projecting lens set is disposed on the other side in the frame and receives the display light. Besides, the optical projecting lens set emits projection light to a retina and forms a display image. The present invention uses the optical projecting lens set to emit the display light to a retina and form the display image. Thereby, a user can know environmental parameters without stopping. In addition, by means of retina imaging, external obstruction on images can be prevented and hence enhancing convenience as well as safety of skiing.

### FIELD OF THE INVENTION

The present invention relates generally to an optical digital display apparatus, and particularly to a head-mounted optical digital display apparatus.

### BACKGROUND OF THE INVENTION

People's living qualities are elevated owing to progress and prosperity in global economics, and thereby they make much of leisure activities. In recent years, skiing is a fairly attractive leisure sport. The sport is breathtaking as well as exciting. People taking part in the sport not only can get close to the nature, but also can enjoy hauntingly stimulating experience brought about by extremely fast speed. Nonetheless, the temperature in skiing fields is very low. Besides, people are accelerated to a certain speed while skiing. Thereby, it is necessary to have thorough preparation before undergoing skiing for ensuring safety. Accordingly, in addition to warmth-keeping clothes, gloves, caps, and snow goggles are fundamental equipment for skiing sport.

A pair of snow goggles is an important part of skiing equipment. In snow grounds, it is easy to have sunlight reflection. When the degree of reflection is strong, skiers may have snow blindness. Moreover, cold wind will stimulate skiers' eyes fiercely while they are skiing. Consequently, skiers have to use snow goggles for protecting their eyes. Skiing is an exciting exercise. In addition to protection equipment, skiers also must pay close attention to other environmental factors, such as time, temperature, altitude, and direction, for enhancing safety while skiing.

Nevertheless, the skiing speed is so fast that skiers cannot comprehend such environmental parameters as the time, temperature, altitude, or direction at that instant. For knowing the environmental parameters, skiers need to stop first and then take out various apparatuses of environmental parameters for time, temperature, altitude, or direction for reading. Such multifarious actions lead to inconvenience for skiers. It will be more convenient for a skier if he can find a single apparatus of environmental parameters capable of telling time, temperature, altitude, and direction simultaneously. However, the single apparatus still does not solve the problem that a skier has to stop before he can read the readings.

Currently, there is a projection-like technology, which uses lenses to focus and project images to a user. However, when a skier using this method needs to know the environmental parameters, he has to adjust his focal point to a closer place, which is not suitable for skiing because it may lead to inconvenience or even affect safety. Besides, this method projects images to snow goggles. The projected images may be obstructed due to external interference. This also brings safety concerns to the snow goggles according to the prior art.

Accordingly, the present invention provides a digital display apparatus, which enables a skier to know environmental parameters such as time, temperature, altitude, or direction without stopping. It also can avoid images from external obstruction. Thereby, the problems described above can be solved.

### SUMMARY

An objective of the present invention is to provide an optical digital display apparatus, which uses an optical projecting lens set to receive display light of a display module, emit projection light to a retina, and form a display image. Thereby, a user can know environmental parameters without stopping. In addition, by means of retina imaging, external obstruction on images can be prevented and hence enhancing convenience as well as safety of skiing.

The optical digital display apparatus according to the present invention comprises a housing, at least a display module, and an optical projecting lens set. The housing has a frame. The display module is disposed on one side in the frame and emits display light. The optical projecting lens set is disposed on the other side in the frame and receives the display light. Besides, the optical projecting lens set emits projection light to a retina and forms a display image.

### BRIEF DESCRIPTION OF THE DRAWINGS

FIG. 1 shows a structural schematic diagram of an optical digital display apparatus according a preferred embodiment of the present invention;

FIG. 2 shows a structural schematic diagram of an optical projecting lens set having digital displaying capability according a preferred embodiment of the present invention;

FIG. 3A shows a status diagram for various environmental parameters of the display module on the L side; and

FIG. 3B shows a status diagram for various environmental parameters of the display module on the R side.

### DETAILED DESCRIPTION

In order to make the structure and characteristics as well as the effectiveness of the present invention to be further understood and recognized, the detailed description of the present invention is provided as follows along with embodiments and accompanying figures.

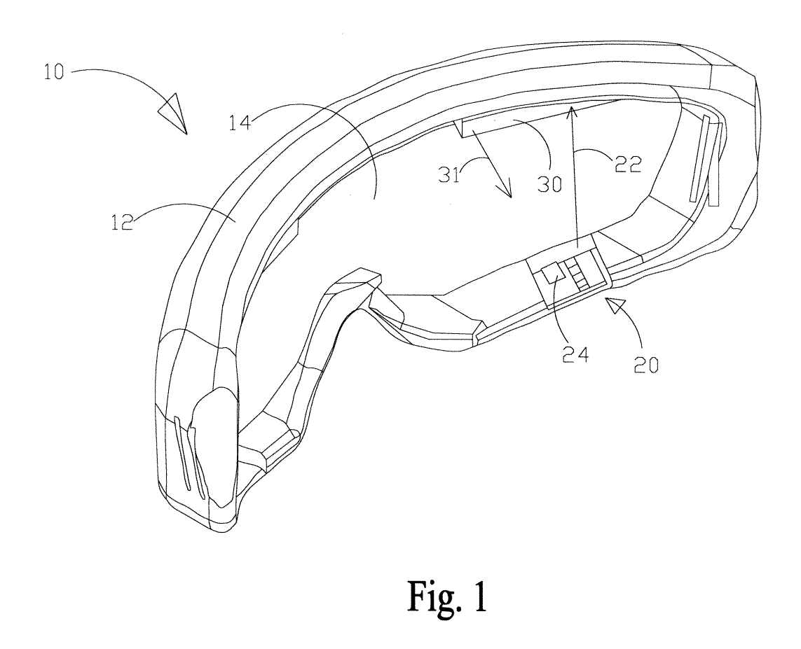

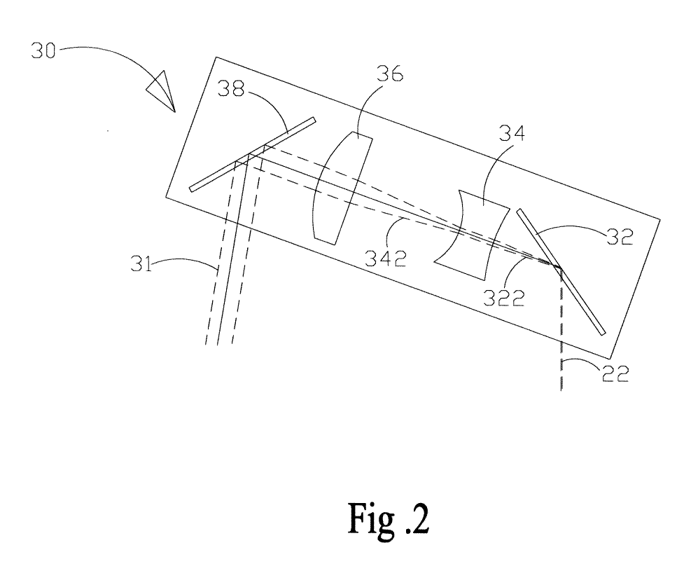

FIG. 1 and FIG. 2 show structural schematic diagrams of an optical digital display apparatus and an optical projecting lens set according a preferred embodiment of the present invention. As shown in the figures, the optical digital display apparatus according to the present invention comprises a housing 10, at least a display module 20, and an optical projecting lens set 30. The housing 10 has a frame 12, which can have a lens 14. The display module 20 is disposed on one side in the frame 12 and emits display light 22. The optical projecting lens set 30 is disposed on the other side in the frame 12 and receives the display light 22. Besides, the optical projecting lens set 30 emits projection light 31 to a retina of a human eye and forms a display image.

The optical projecting lens set 30 comprises a first reflection lens 32, an object lens 34, an ocular lens 36, and a second reflection lens 38. The first reflection lens 32 receives and reflects the display light 22 and emits first light 322. The object lens 34 receives the first light 322 and emits second light 342. The ocular lens 36 receives the second light 342 and emits third light 362. The second reflection lens 38 receives the third light 362 and emits the projection light 31. The third light 362 is reflected in parallel and forming the projection light 31.

The optical projecting lens set 30 according to the present invention can image messages from the 1 cm-by-2 cm display module 20 on a human eye. The image projection needs to pass the pupil of an eye. The diameter of a human pupil is 2.5 to 4 mm. 2 hihc makes the viewing angles of images in both direction be 2 to 5 degrees and 4 to 10 degrees, respectively. In addition, the optical projecting lens set 30 does not exhibit off-axis or tilt with respect to the light on the axis. For improving imaging quality, the optical projecting lens set 30 according to the present invention adopts two lenses. The object lens 34, which is a concave lens, first images the object. The first light 322 images at the focal point of the object lens 34. The image formed by the object lens 34 falls at the focal point of the ocular lens 36, which is a convex lens. The second light 342 forms a virtual image on the second reflection lens 38. Thereby, the image forms a virtual image behind the ocular lens 36 and the virtual image is projected in parallel to the retina of a human. The present invention uses the optical projecting lens set 30 to emit the display light 22 to a retina and form the display image. Thereby, a user can know environmental parameters without stopping. In addition, by means of retina imaging, external obstruction on images can be prevented and hence enhancing convenience as well as safety of skiing.

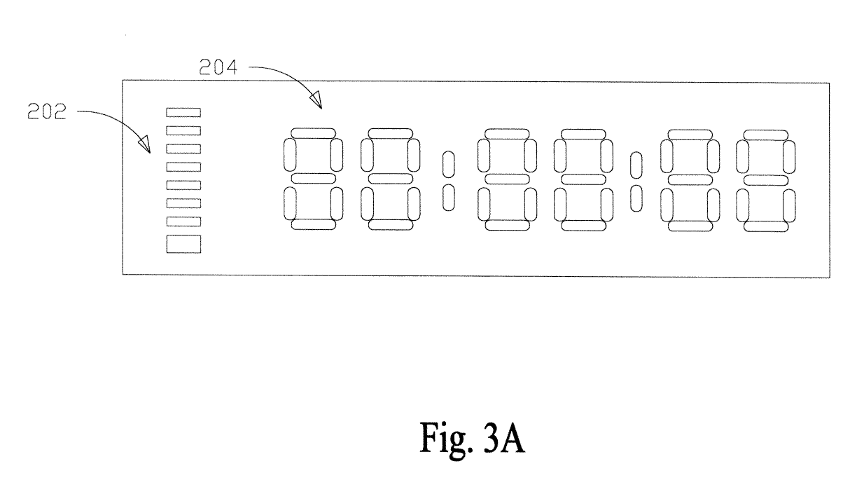

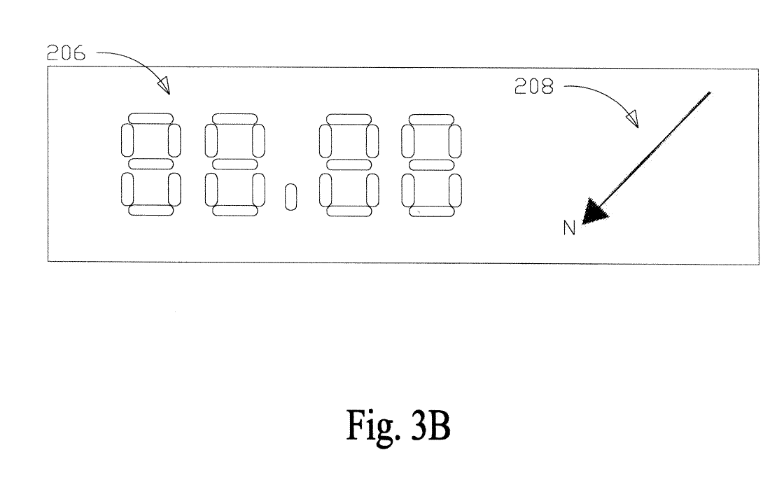

FIGS. 3A and 3B show status diagrams for various environmental parameters of the display module. As shown in the figures, the display module 20 is used for displaying environmental parameters. For example, the display module 20 can be a time display module, a temperature display, an altitude display module, or a direction display module. An altitude parameter 202 and a time parameter 204 are shown in FIG. 3A; a temperature parameter 206 and a direction parameter 208 are shown in FIG. 3B. In addition to time display unit, the display module 20 further includes a sensor 24, which can be a temperature sensor, an altitude sensor, or a direction sensor. The direction sensor can be a general global positioning system (GPS). In order to reduce the volume of the optical digital display apparatus, the display module can further include a wireless transmission module for receiving the data of the direction sensor. Thereby, a skier can comprehend his own location via GPS. Moreover, the GPS can also plan skiing routes, further increasing a user's convenience.

In addition to snow goggles, the present invention can also be auxiliary equipment to sporting or protective eyeglasses or be an apparatus disposed relative to eyes. Besides, it can further be a digital guiding apparatus. In addition to disposing a wireless transmission module in the display module 20, the housing 10 can further has a photosensor. The photosensor and an image processing apparatus can transmit signals with each other. The photosensor extracts images and the image processing apparatus processes them. The processed images are then projected to human eyes. By using the head-mounted optical digital display apparatus, the safety and efficiency for long-term inspection or experimental works in dangerous environments can be substantially improved.

To sum up, the optical digital display apparatus according to the present invention comprises a housing, at least a display module, and an optical projecting lens set. The housing has a frame. The display module is disposed on one side in the frame and emits display light. The optical projecting lens set is disposed on the other side in the frame and receives the display light. Besides, the optical projecting lens set emits projection light to a retina and forms a display image. The present invention uses the optical projecting lens set to emit the display light to a retina and form the display image. Thereby, a user can know environmental parameters without stopping. In addition, by means of retina imaging, external obstruction on images can be prevented and hence enhancing convenience as well as safety of skiing.

Accordingly, the present invention conforms to the legal requirements owing to its novelty, nonobviousness, and utility. However, the foregoing description is only embodiments of the present invention, not used to limit the scope and range of the present invention. Those equivalent changes or modifications made according to the shape, structure, feature, or spirit described in the claims of the present invention are included in the appended claims of the present invention.

1. An optical digital display apparatus, comprising:
a housing, having a frame;
at least a display module, disposed on side in said frame and emitting display light; and
at least an optical projecting lens set, disposed on the other side in said frame, receiving said display light, and emitting projection light to a retina and forming a display image.

2. The optical digital display apparatus of claim 1, wherein said display module is a time display module.

3. The optical digital display apparatus of claim 1, wherein said display module further comprises a sensor.

4. The optical digital display apparatus of claim 1, wherein said display module is a temperature display module.

5. The optical digital display apparatus of claim 1, wherein said display module is an altitude display module.

6. The optical digital display apparatus of claim 1, wherein said display module is a direction display module.

7. The optical digital display apparatus of claim 1, wherein said optical projecting lens set comprises:
a first reflection lens, receiving said display light and emitting first light;
an object lens, receiving said first light and emitting second light;
an ocular lens, receiving said second light and emitting third light; and
a second reflection lens, receiving said third light and emitting said projection light.

8. The optical digital display apparatus of claim 7, wherein said first light images at the focal point of said object lens.

9. The optical digital display apparatus of claim 7, wherein said second light forms a virtual image at said second reflection lens.

10. The optical digital display apparatus of claim 7, wherein said third light is reflected in parallel and forming said projection light.

11. The optical digital display apparatus of claim 7, wherein said object lens is a concave lens.

12. The optical digital display apparatus of claim 7, wherein said ocular lens is a convex lens.
